(19) United States
(12) Patent Application Publication
(10) Pub. No.: US 2011/0154299 A1
(43) Pub. Date: Jun. 23, 2011

(54) APPARATUS AND METHOD FOR EXECUTING INSTRUMENTATION CODE

(75) Inventors: Hyo-Young KIM, Suwon-si (KR); Sung-Do Moon, Seongnam-si (KR); Jung-Gyu Park, Yongin-si (KR)

(73) Assignee: SAMSUNG ELECTRONICS CO., LTD., Suwon-si (KR)

(21) Appl. No.: 12/856,896

(22) Filed: Aug. 16, 2010

(30) Foreign Application Priority Data
Dec. 18, 2009 (KR) 10-2009-0127298

(51) Int. Cl. G06F 9/44

(52) U.S. Cl. 717/130

(57) ABSTRACT

An instrumentation apparatus and method capable of adding an additional operation to an execution program, are provided. A processor for supporting instrumentation assigns an instrumentation bit to an instruction that includes instrumentation code that needs to be executed. The processor jumps to an address of a memory for execution of the instrumentation code, and stores the jump address in a register. If a fetched instruction includes the instrumentation bit, the processor jumps to the jump address stored in the register and executes the instrumentation code.

### CROSS-REFERENCE TO RELATED APPLICATION(S)

This application claims the benefit under 35 U.S.C. §119(a) of Korean Patent Application No. 10-2009-0127298, filed on Dec. 18, 2009, the entire disclosure of which is incorporated herein by reference for all purposes.

### BACKGROUND

1. Field

The following description relates to a data processing technology, and more particularly, to an apparatus and method for executing instrumentation and for monitoring information about the execution of a software application.

2. Description of the Related Art

A program may perform an abnormal operation that is not intended by a programmer, for example, due to programming mistakes, unexpected variables, and the like. In order to analyze such an abnormal or unexpected operation, the execution of a program code needs to be identified. Such an analysis is referred to as a profiling. The profiling may be implemented using various schemes such as an instrumentation scheme which is widely used among the profiling schemes.

In a binary instrumentation scheme, which is one kind of instrumentation scheme, compiled binary code of an application to be instrumented is modified into an instrumentation code and the instrumentation code can serve as a part of the software application and be executed along with the application. The instrumentation code includes a set of instructions that are used to obtain information about operations or events occurring when the software application is being executed. The set of instructions may represent one or more instructions.

The binary instrumentation does not require a source code and a compiling time, but requires a large amount of memory and time in analyzing and relocating the code of a program to modify the code such that a desired operation is executed. In an example where an original code of a program is relocated to another address, if an instruction required to access the relocated code exists, an access address needs to be modified such that the instruction can access the relocated code. Such a change may require the modification of a large number of instructions resulting in a large amount of operations. In addition, if a conditional flag exists among instructions to be instrumented, an instrumentation code execution may be unintentionally performed on an instruction that is not to be executed. Accordingly, inaccuracy in the instrumentation may occur.

### SUMMARY

In one general aspect, there is provided an apparatus for executing instrumentation code, the apparatus including: a code converter configured to: assign, to an instruction, an instrumentation bit that indicates that the instruction includes instrumentation code that needs to be executed, and set an address of a memory to which a jump is made for executing instrumentation code, a register configured to store the address of the memory, and a controller configured to: fetch an instruction, and in response to the fetched instruction having the instrumentation bit assigned thereto, pause the execution of the instruction and make a jump to the address of the memory to execute the instrumentation code.

The apparatus may further include that the register is further configured to store an address of the instruction which is assigned the instrumentation bit.

The apparatus may further include that, upon completion of the execution of the instrumentation code, the controller is further configured to continue with executing the instruction, using the address of the instruction.

The apparatus may further include that the register is further configured to store a stack pointer that is used to execute the instrumentation code.

The apparatus may further include that the register is further configured to store an address of information that is generated during the execution of the instruction before the execution of the instruction is paused.

The apparatus may further include that, in response to the execution of the instrumentation code being completed, the controller is further configured to restore the information, which is generated during the execution of the instruction prior to the jump, using the address of the information generated during the execution of the instruction.

The apparatus may further include that: the fetched instruction includes a condition bit and an instrumentation bit, and the controller is further configured to execute the instrumentation is code in response to the condition bit indicating that the instruction is to be executed and the instrumentation bit indicating that instrumentation code is to be executed.

In another general aspect, there is provided a method of executing instrumentation including: assigning an instrumentation bit to an instruction, the instrumentation bit indicating that the instruction includes instrumentation code that needs to be executed, setting an address of a memory to which a jump is made for executing the instrumentation code, and in response to a fetched instruction having the instrumentation bit assigned thereto, pausing the processing of the instruction and jumping to an address of memory to execute the instrumentation code.

The method may further include: storing an address of the instruction which is assigned the instrumentation bit before executing the instrumentation code, and after the execution of the instrumentation code, continuing with execution of the paused instruction using the address of the instruction.

The method may further include storing a stack pointer used to execute the instrumentation code before executing the instrumentation code. The method may further include: storing an address of information that is generated during the execution of the instruction before the execution of the instruction is paused, and after the execution of the instrumentation code, restoring the information, which is generated during the execution of the instruction prior to the jump, using the address of the information generated during the execution of the instruction.

In another general aspect, there is provided a processor, including: a code converter configured to: retrieve a program from memory, convert the program into one or more instructions, assign an instrumentation bit to at least one instruction to indicate that the instruction includes instrumentation code, and store the one or more instructions in the memory, and a controller configured to: fetch an instruction from memory, and in response to the is fetched instruction being assigned the instrumentation bit, pause the processing of the fetched instruction and jump to an address in the memory to execute the instrumentation code.

The processor may further include that the controller is further configured to: store an instruction address of the fetched instruction in the memory, and upon completion of the execution of the instrumentation code, begin executing the paused instruction based on the stored instruction address.

The processor may further include that the controller is further configured to obtain trace information about the instruction by executing the instrumentation code.

Other features and aspects may be apparent from the following description, which, the drawings, and the claims.

### BRIEF DESCRIPTION OF THE DRAWINGS

FIG. 1 is a diagram illustrating an example of an apparatus for executing instrumentation code.

FIG. 2 is a diagram illustrating an example of the format of an instruction set including an instrumentation bit.

FIG. 3 is a diagram illustrating an example of a program code converted by the code converter of a processor.

FIG. 4 is a diagram illustrating an example of a register included in a processor.

FIG. 5 is a flowchart illustrating an example of a method for executing instrumentation code.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

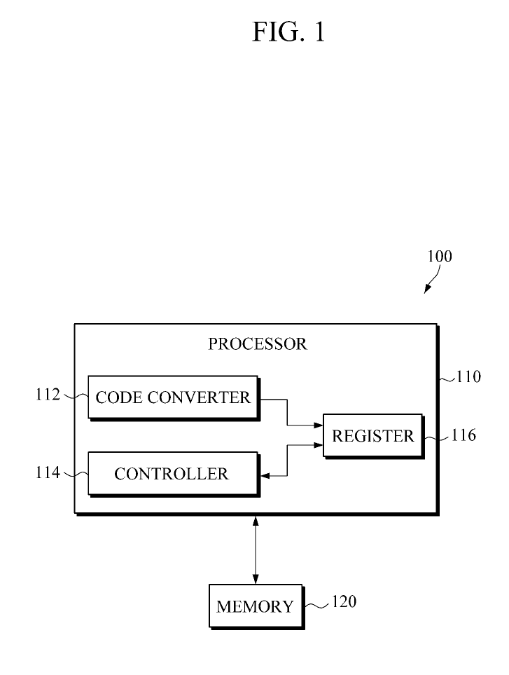

FIG. 1 illustrates an example of an apparatus for executing instrumentation.

Referring to FIG. 1, apparatus 100 for executing instrumentation code includes a processor 110 and a memory 120. The apparatus 100 may be included in a terminal such as a mobile phone, a computer, and the like.

The processor 110 executes instructions based on data stored in the memory 120. The memory 120 may include an Instruction Set Architecture (ISA) encoding map that may be used to produce a program code to be processed by the processor 110 and to be executed. The program code stored in the memory 120 may be loaded by the processor 110.

Processor 110 includes a code converter 112, a controller 114 and a register 116. In this example, the code converter 112 and the controller 114 are provided as separate units. According to another example, the code converter 112 and the controller 114 may be integrally formed with each other, or the controller 114 may be divided into a plurality of functional blocks according to various functions.

The code converter 112 performs compiling to convert a program that is input from the is memory 120 into instructions that may be processed in the controller 114, with reference to the ISA encoding map. The converted instructions may be stored in the memory 120, and the controller 114 may fetch and execute the instructions stored in the memory 120.

On the ISA encoding map an instruction that needs to be executed may include an instrumentation bit indicating that instrumentation code needs to be executed.

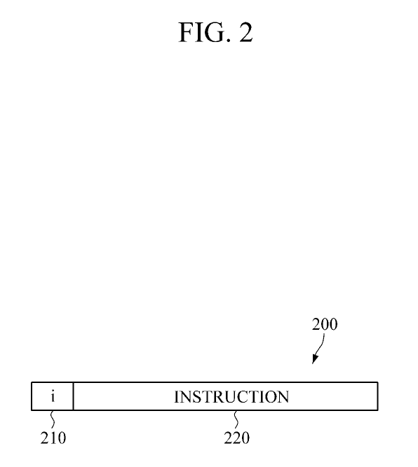

FIG. 2 illustrates an example of the format of an instruction set including an instrumentation bit.

Referring to FIG. 2, an instruction set architecture 200 of an instruction to be executed includes a general instruction structure 220 including an operation code and a condition bit. The instruction set architecture 200 may further include an instrumentation bit or an instrumentation flag 210 that indicates the possibility of instrumentation code that needs to be executed.

Referring again to FIG. 1, the code converter 112 fetches a program from the memory 120, and if an instruction that includes instrumentation code that needs to be executed is encountered, the code converter 112 may assign an instrumentation bit to the instruction to indicate that the instruction needs to be subject to instrumentation execution. If the ISA encoding map does not include an instrumentation bit, the code converter 112 may set one of reserved bits of a general instruction set architecture to act as the instrumentation bit. Accordingly, the instrumentation bit allows the controller 114 to identify that a jump needs to be performed such that the controller 114 jumps to an instrumentation code that needs to be executed.

The code converter 112 sets an address of a memory in the register 116 corresponding to an address that the controller 114 needs to jumps to. In addition, the code converter 112 may store a stack pointer that may be used to execute an instrumentation code, in the register 116. If an instrumentation bit indicating the need for instrumentation code execution is assigned to a fetched instruction, the controller 114 may perform a jump to the address of the memory that is set by the code converter 112 and stored in the register 116. Accordingly, the processor may execute the instrumentation code. The controller 114 may serve as an instrumentation handler when the instrumentation code is executed.

The controller 114 may acquire trace information on a program by executing the instrumentation code. The trace information may include the frequency of an event, an execution flow, and the like. The trace information acquirable by the controller 114 may vary depending on the contents of code.

In addition to a general register, the register 116 may include an additional register storing, for example, an address of an instrumentation code that is used to execute an operation of the instrumentation handler, an address of an instruction to which an instrumentation bit indicating the need for instrumentation execution is added, a stack pointer used to execute an instrumentation code, and an address of information generated in the execution of an instruction that has been started before a jump.

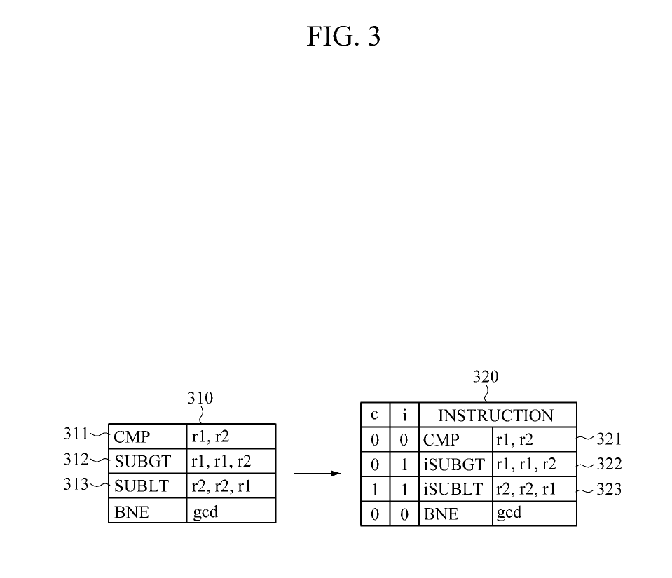

FIG. 3 illustrates an example of a program code converted by a code converter of a processor.

Referring to FIG. 3, in a program code, instruction 311 corresponds to an operation of executing a comparison between values stored in a register r1 and a register r2, respectively. Instruction 312 corresponds to an operation in which the value stored in the register r2 is subtracted from the value stored in the register r1 in an example where the value stored in the register r1 is larger than the value stored in the register r2. The result of the subtraction may be stored in the register r1. Instruction 312 corresponds to an operation in which the value stored in the register r1 is subtracted from the value stored in the register r2 in an example where the value stored in the register r1 is smaller than the value stored in the register r2. The result of is the subtraction may be stored in the register r2.

When the instructions 312 and 313 are executed based on the comparison result of the instruction 311, only one of the instructions 312 and 313 may be executed at a time, even through both of the instructions 312 and 313 are subject to instrumentation. However, a general binary instrumentation is applied to the program code 310, causing an error that the instruction 312 and the instruction 313 are subject to an instrumentation code execution.

For example, the code converter 112 may compile a program code 310 into a program code 320. In this example, the generated program code 320 includes a condition bit c indicating the feasibility of a conditional execution and an instrumentation bit i indicating the need for instrumentation code execution.

For example, if the condition bit c is set to “0”, this may indicate that the instruction is not to be executed, whereas if the condition bit c is set to “1” this may indicate that the instruction is to be executed. In another example, if the instrumentation bit i is set to “0” this may indicate that the instruction is not to be subject to the execution of instrumentation code, whereas, if the instrumentation bit i is set to “1” this may indicate that the instruction is to be subject to the execution of instrumentation code.

Accordingly, the controller 114 may execute an instruction 321 and check the condition bit c of instruction 322 to determine if instruction 322 needs to be executed. For example, if the condition bit c of the instruction 322 is “0”, the controller 114 does not execute the instruction 322 and fetches an instruction 323. In another example, if the instruction 323 has a condition bit c set to “1” and an instrumentation bit i set to “1”, the controller 115 performs the execution of the instrumentation code on the instruction 323 before the execution of the instruction 323 itself.

Accordingly, the instrumentation scheme using the processor 110 may provide improved is instrumentation speed, reduce memory use, and improve the accuracy of instrumentation as compared with a general instrumentation method using a binary instrumentation software. In comparison to the binary instrumentation, the example of the instrumentation scheme using the processor 110 may reduce the provision time and the amount of memory required to measure the performance of a system and provide precise results of measurement.

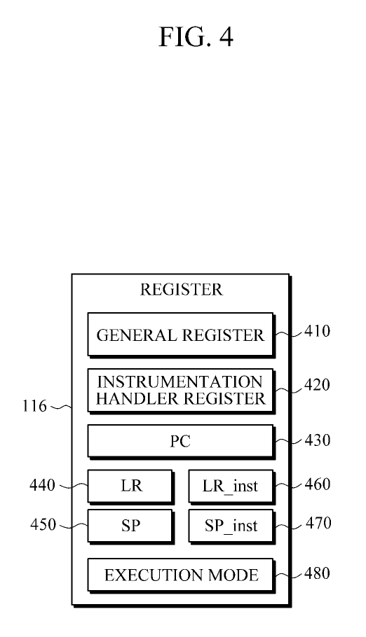

FIG. 4 illustrates an example of a register included in a processor.

Referring to FIG. 4, register 116 includes a general register 410, an instrumentation handler register 420, a program counter 430, a link register 440, a stack pointer 450, a link register_inst (instrumenation) 460, a stack pointer_inst (instrumenation) 470, and an execution mode register 480.

The general register 410 may be used as a register to store the status of the processor 110 and operands or operation results of data processing instructions. The general register 410 may be used to calculate a memory access address of a memory access instruction.

The instrumentation handler register 420 stores an address of an instrumentation code that is used to execute the operation of an instrumentation handler.

The program counter 430 may automatically increase with the execution of sequential instructions and has an address of an instruction to be executed.

The link register 440 stores a return address for functional calling or for an unexpected event. The link register 440 may be provided based on the operation mode of the processor.

The stack pointer 450 is a register that points to the top of a stack. The stack may be allocated based on the operation mode of the processor. Similar to the link register 440, the stack pointer 450 may be provided based on the operation mode of the processor.

The link register_inst 460 stores a return address that is used to return to an original mode. The original mode corresponds to a mode used before a jump is made to process an is instrumentation code. That is, the link register_inst 460 may store an address of an instruction to which an instrumentation bit is assigned.

The stack pointer_inst 470 stores an address of a stack that is used in the execution of an instrumentation code.

The execution mode register 480 may be used when the controller has at least one execution mode. The execution mode register 480 structure may be provided in various forms.

As shown in FIGS. 1 and 4, for the purpose of instrumentation, the code converter 112 may store an address of instrumentation code or an instrumentation handler For example, the code converter 112 may store address 0×b7120000 in the instrumentation handler register 420. In addition, the code converter 112 may store a stack pointer value to be used for instrumentation in advance in the stack pointer_inst 470.

Accordingly, the controller 115 may fetch an instruction and if an instrumentation bit is assigned to the fetched instruction, the controller may execute an instrumentation code by jumping to an address of a branch memory that is stored in the handler register 420. In addition, the controller 114 may perform the execution of an instrumentation code using data of a stack that is being pointed to by the stack pointer.

In addition, if the controller 114 encounters an instruction that needs instrumentation execution, the controller 114 may store an address of the corresponding instruction in a link register_inst 460. After the execution of the instrumentation code, the controller 114 may return to a return address of the instruction using an address stored in the link register_inst 460. The return address corresponds to an address of the instruction being executed before the jump. Accordingly, the controller 114 may continue with the execution of the instruction.

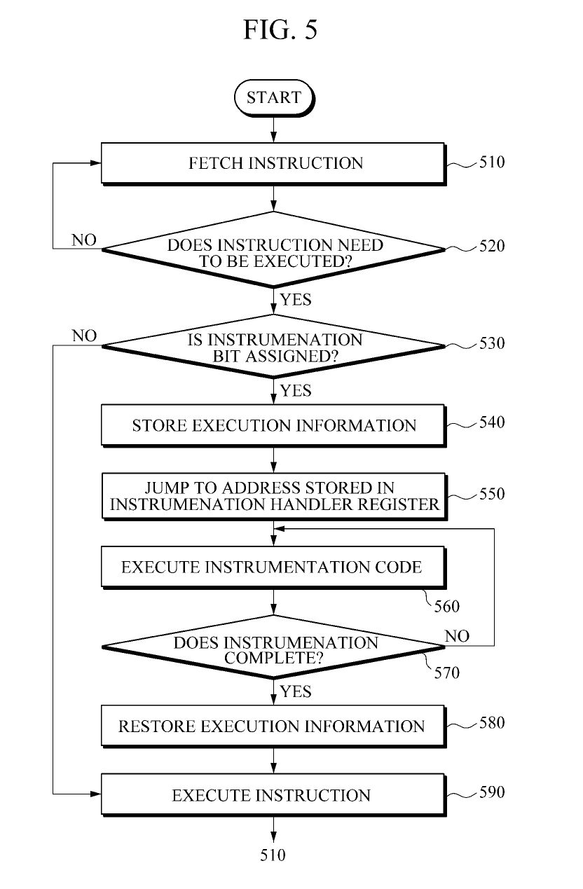

FIG. 5 illustrates an example of a method of executing instrumentation code.

Hereinafter, referring to FIGS. 1, 4, and 5, a process of executing instrumentation code is described. For convenience, it is assumed that the system has an Instruction Set Architecture ISA to which an instrumentation bit is added. In this example, as shown in FIG. 4, the system further implements an instrumentation mode, and further includes the instrumentation handler register 420, the link register_inst 460, and the stack pointer_inst 470 for the instrumentation mode.

Referring to FIG. 5, in operation 510 the controller 114 fetches an instruction. In operation 520 the controller 114 determines if the fetched instruction needs to be executed by checking a condition bit. If the fetched instruction does not need to be executed, the method reverts back to operation 510 and the controller 114 fetches a next instruction. This cycle continues until an instruction needs to be executed.

If the fetched instruction needs to be executed in operation 520, the controller 114 determines if the instruction needs to be subject to instrumentation execution by checking if an instrumentation bit is assigned to the instruction in operation 530. The instrumentation bit indicates the need for an instrumentation code to be executed.

If the instruction bit is assigned to the instruction, in operation 540 the controller 114 stores information which has been generated in the execution of the instruction. The controller 114 stores the information which has been generated in the execution of the instruction in the memory 120 and stores an address of the corresponding information in a certain register. In addition, in operation 540, the controller 115 enters a value of the program counter 430 as a value of the link register_inst 460, thereby storing an address of a memory to which a return is made after the completion of the execution of the instrumentation code.

In operation 550 the controller 114 enters an instrumentation execution mode, and jumps to an address stored in the instrumentation handler register 420 to execute an instrumentation code in operation 560. For example, in order to execute the instrumentation code, the controller 114 may enter an address of the instrumentation code stored in the instrumentation handler register 420 in the program counter 430 and fetch an instruction corresponding to an is instrumentation code that is used to execute a function of the instrumentation handler.

After the execution of all instrumentation codes, if the controller 114 encounters a return code and then needs to complete the instrumentation in operation 570, the controller 114 restores execution information in operation 580. The controller 114 may restore execution information that is generated in the execution of the instruction which was started before the jump. The instruction may be restored to the general register 410 using the address of the information stored in operation 540.

In operation 590, the controller 114 jumps to an original address of the instruction and executes the instruction that is assigned an instrumentation bit and is not executed yet. Sequentially, the controller 114 processes a next instruction, returning to operation 510. To this end, the controller 114 may return to an original execution code by moving a value of the link register_inst 460 to the program counter 430.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and is files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller.

The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for executing instrumentation code, the apparatus comprising:
a code converter configured to:
assign, to an instruction, an instrumentation bit that indicates that the instruction comprises instrumentation code that needs to be executed; and
set an address of a memory to which a jump is made for executing instrumentation code;
a register configured to store the address of the memory; and
a controller configured to:
fetch an instruction; and
in response to the fetched instruction having the instrumentation bit assigned thereto, pause the execution of the instruction and make a jump to the address of the memory to execute the instrumentation code.

2. The apparatus of claim 1, wherein the register is further configured to store an address of the instruction which is assigned the instrumentation bit.

3. The apparatus of claim 2, wherein, upon completion of the execution of the instrumentation code, the controller is further configured to continue with executing the instruction, using the address of the instruction.

4. The apparatus of claim 1, wherein the register is further configured to store a stack pointer that is used to execute the instrumentation code.

5. The apparatus of claim 1, wherein the register is further configured to store an address of information that is generated during the execution of the instruction before the execution of the instruction is paused.

6. The apparatus of claim 5, wherein, in response to the execution of the instrumentation code being completed, the controller is further configured to restore the information, which is generated during the execution of the instruction prior to the jump, using the address of the information generated during the execution of the instruction.

7. The apparatus of claim 1, wherein:
the fetched instruction comprises a condition bit and an instrumentation bit; and
the controller is further configured to execute the instrumentation code in response to the condition bit indicating that the instruction is to be executed and the instrumentation bit indicating that instrumentation code is to be executed.

8. A method of executing instrumentation, the method comprising:
assigning an instrumentation bit to an instruction, the instrumentation bit indicating that the instruction comprises instrumentation code that needs to be executed;
setting an address of a memory to which a jump is made for executing the instrumentation code; and
in response to a fetched instruction having the instrumentation bit assigned thereto, pausing the processing of the instruction and jumping to an address of memory to execute the instrumentation code.

9. The method of claim 8, further comprising:
storing an address of the instruction which is assigned the instrumentation bit before executing the instrumentation code; and
after the execution of the instrumentation code, continuing with execution of the paused instruction using the address of the instruction.

10. The method of claim 8, further comprising storing a stack pointer used to execute the instrumentation code before executing the instrumentation code.

11. The method of claim 8, further comprising:
storing an address of information that is generated during the execution of the instruction before the execution of the instruction is paused; and
after the execution of the instrumentation code, restoring the information, which is generated during the execution of the instruction prior to the jump, using the address of the is information generated during the execution of the instruction.

12. A processor, comprising:
a code converter configured to:
retrieve a program from memory;
convert the program into one or more instructions;
assign an instrumentation bit to at least one instruction to indicate that the instruction comprises instrumentation code; and
store the one or more instructions in the memory; and
a controller configured to:
fetch an instruction from memory; and
in response to the fetched instruction being assigned the instrumentation bit, pause the processing of the fetched instruction and jump to an address in the memory to execute the instrumentation code.

13. The processor of claim 12, wherein the controller is further configured to:
store an instruction address of the fetched instruction in the memory; and
upon completion of the execution of the instrumentation code, begin executing the paused instruction based on the stored instruction address.

14. The processor of claim 12, wherein the controller is further configured to obtain trace information about the instruction by executing the instrumentation code.
